(19) United States
(12) Patent Application Publication
(10) Pub. No.: US 2026/0328924 A1
(43) Pub. Date: Oct. 22, 2026

(54) MOTION DETECTION RADAR DEVICE

(71) Applicant: STMicroelectronics International N.V., Geneva (CH)

(72) Inventor: Julien DUPEYROUX, La Buisse (FR)

(73) Assignee: STMicroelectronics International N.V., Geneva (CH)

(21) Appl. No.: 19/084,258

(22) Filed: Mar. 19, 2025

(30) Foreign Application Priority Data
Mar. 28, 2024 (FR) FR2403169

(51) Int. Cl. G01S 13/62; G01S 7/03; G01S 7/41; G06T 7/262

(52) U.S. Cl. CPC G01S 13/62; G01S 7/03; G01S 7/418; G06T 7/262; G06T 2207/10028; G06T 2207/20061; G06T 2207/30252

(57) ABSTRACT

A motion detection radar device includes a transceiver circuit configured to transmit a sequence of radar waves and receive a sequence of reflected radar waves. At least a first raster image representative of a spatiotemporal distribution of the energy of the reflected radar waves is stored in a memory circuit. A processing circuit implements at least one comparison, based on at least a portion of the first raster image, of the spatiotemporal distribution of the energy of reflected radar waves with an expected spatiotemporal energy distribution. The expected spatiotemporal energy distribution corresponds to at least one movement that is intended to be detected by the motion detection radar device.

### PRIORITY CLAIM

This application claims the priority benefit of French Application for Patent No. 2403169, filed on Mar. 28, 2024, the content of which is hereby incorporated by reference in its entirety to the maximum extent allowable by law.

### TECHNICAL FIELD

The present disclosure generally concerns the field of motion detection devices.

### BACKGROUND

Many vehicles are equipped with a device enabling to control opening and closing of the vehicle trunk door without for the user of the vehicle having to press a control button. Such a device greatly improves the user's comfort when their hands are not free, for example when they carry a bulky object or when they are physically unable to manually open and close the trunk door.

Typically, such a device comprises a millimeter-wave (mmWave) radar sensor having frequencies generally in the range from 40 GHz to 300 GHz, and which generates images based on the Doppler effect. These images are processed by computer tools using, for example, artificial intelligence such as classification techniques, to detect an expected movement generated by the user at the rear of the vehicle, generally a “kicking” movement, that is, a rapid back-and-forth motion of the foot, performed under the rear bumper of the vehicle.

Such devices are, however, sensitive to noise. Indeed, millimeter-wave radar devices use high-amplitude radar signals. Now, the greater the amplitude of the radar signal, the greater the received echo intended to be processed by the device, and the more significant the false echoes, which can interfere with the processing of the received echo signal.

Further, such a device is generally on-board the vehicle, which can generate interference with the other radar devices present in the vehicle, and lead to a partial or total destruction of the useful part of the data to be processed to detect the motion. This implies the use of filtering techniques that can be costly, in particular when they are on-board, and also generates a risk of erroneous detections.

Further, artificial intelligence tools used to process the received radar echoes require a specific training which may not be compatible with all vehicle types or models, since this training may be necessary for each different model, or even for each vehicle. Further, these solutions are often computer resource-intensive. Finally, according to the training sequence used, this solution may not be robust over time.

There exists a need for a motion detection radar device which does not have at least some of the disadvantages of known solutions.

### SUMMARY

An embodiment overcomes all or part of the disadvantages of known motion detection radar devices and provides a motion detection radar device comprising at least: a transceiver circuit configured to transmit a sequence of radar waves and to receive a sequence of reflected radar waves or radar echoes; a memory circuit configured to store at least a first raster image representative of a spatiotemporal distribution of the energy of the reflected radar waves; and a processing circuit configured to implement at least one comparison, based on at least a portion of the first raster image, of the spatiotemporal distribution of the energy of the reflected radar waves with an expected spatiotemporal energy distribution for at least one movement intended to be detected.

According to a specific embodiment, the processing circuit is configured so that the implemented comparison comprises an application of a Hough transform on said at least a portion of the first raster image, and configured to determine the value of a first motion detection variable as a function at least of values of slopes of lines obtained by the application of the Hough transform to said at least a portion of the first raster image.

According to a specific embodiment, the processing circuit is configured to determine that the movement is detected if at least: the absolute values of the slopes of two lines obtained by the application of the Hough transform are equal and the values of these slopes are opposite, or a difference between the absolute values of the slopes of two lines obtained by the application of the Hough transform is smaller than a threshold value of the difference between slopes, and the values of these slopes are opposite.

According to a specific embodiment, the processing circuit is further configured to determine that the movement is detected when a difference between the sums of pixel values having each of the two lines running therethrough is smaller than a threshold value of the difference between sums of pixel values and/or the sums of pixel values of each of the two lines are smaller than those of predefined lines.

According to a specific embodiment, the processing circuit is configured so that the implemented comparison comprises at least a calculation of a correlation between said at least a portion of the first raster image and at least a second raster image in which a first part of the pixels have their values defined at a maximum value and a second part of the pixels have their values defined at a minimum value, and configured to determine the value of a second motion detection variable as a function of a result of a comparison between at least one statistical characteristic of a result of the calculated correlation and a threshold correlation value.

According to a specific embodiment, the processing circuit is configured so that the statistical characteristic corresponds to: the sum of the values of the pixels of a third raster image corresponding to the result of the calculated correlation, or the maximum value of the pixels of the third raster image, or the mean value of the pixels of the third raster image, or the value of the ratio of the standard deviation to the mean of the values of the pixels of the third raster image.

According to a specific embodiment, the processing circuit is configured so that the first part of the pixels of the second raster image corresponds to at least a region of highest energy of the expected spatiotemporal energy distribution.

According to a specific embodiment, the processing circuit is configured so that the comparison is implemented between a position of a maximum value of each of the reflected radar waves and expected positions of a maximum value of an energy generated by the movement intended to be detected, and configured to determine the value of a third motion detection variable as a function of differences between the position of the maximum value of each of the reflected radar waves and expected positions of the maximum value of the energy generated by the movement intended to be detected.

According to a specific embodiment, the processing circuit is configured so that the implemented comparison comprises at least: a calculation of a first vector comprising values of positions of the maximum values of the reflected radar waves; a calculation of a cross-correlation between at least a portion of the first vector and at least a portion of a second vector comprising values of expected positions of the maximum value of the energy generated by the movement intended to be detected; and a comparison of a calculated value of the cross-correlation with a threshold cross-correlation value.

According to a specific embodiment, the processing circuit is configured to confirm the detection or not of the movement as a function of the value of at least one of the first, second, and third detection variables.

According to a specific embodiment, the processing circuit is configured to implement, prior to the comparison, a selection of a portion of the first raster image, the comparison then being implemented based on the selected portion of the first raster image.

According to a specific embodiment, the processing circuit is configured to implement, prior to the comparison, a normalization of the values of the pixels of said at least a portion of the first raster image and a thresholding of the normalized values of the pixels of said at least a portion of the first raster image, and the comparison is implemented based on the normalized and thresholded values of the pixels of said at least a portion of the first raster image.

According to a specific embodiment, the processing circuit is configured to implement, prior to the comparison, a convolution of said at least a portion of the first raster image and of a kernel, and the comparison is then implemented based on a raster image resulting from the convolution of said at least a portion of the first raster image and of the kernel.

According to a specific embodiment, the transceiver circuit is configured to transmit and receive ultra wideband (UWB) type radar waves, and to transmit the radar wave sequence when a user is detected in the vicinity of the motion detection radar device.

There is also provided a vehicle comprising at least one trunk door having its opening and/or its closing controlled by a motion detection radar device.

There is also provided a motion detection method, comprising at least: transmission of a sequence of radar waves; reception of a sequence of reflected radar waves; storage of at least a first raster image representative of a spatiotemporal distribution of the energy of the reflected radar waves; and comparison, based on at least a portion of the first raster image, of the spatiotemporal energy distribution of the reflected radar waves with an expected spatiotemporal energy distribution for at least one movement intended to be detected.

According to a specific embodiment, the method further comprises, prior to the comparison, a selection of a portion of the first raster image, the comparison then being implemented based on the selected portion of the first raster image.

According to a specific embodiment, the method further comprises, prior to the comparison, a normalization of the values of the pixels of said at least a portion of the first raster image and a thresholding of the normalized values of the pixels of said at least a portion of the first raster image, the comparison then being implemented based on the normalized and thresholded values of the pixels of said at least a portion of the first raster image.

According to a specific embodiment, the method further comprises, prior to the comparison, a convolution of said at least a portion of the first raster image and of a kernel, the comparison then being implemented based on a raster image resulting from the convolution of said at least a portion of the first raster image and of the kernel.

According to a specific embodiment, the method further comprises, prior to the transmission of the radar wave sequence, a detection of a user in the vicinity of a motion detection radar device implementing the method, the transmission of the radar wave sequence then being implemented if the user is detected as being in the vicinity of the device.

### BRIEF DESCRIPTION OF THE DRAWINGS

The foregoing features and advantages, as well as others, will be described in detail in the rest of the disclosure of specific embodiments given as an illustration and not limitation with reference to the accompanying drawings, in which:

FIG. 1 schematically shows a vehicle comprising a motion detection radar device;

FIG. 2 schematically shows a motion detection radar device;

FIG. 3 schematically shows an example of a raster image representative of a spatiotemporal distribution of the energy of radar waves reflected and received by a motion detection radar device;

FIG. 4 schematically shows steps of processing of a raster image representative of a spatiotemporal distribution of the energy of radar waves reflected and received by the motion detection radar device, implemented by a processing circuit of a motion detection radar device;

FIG. 5 schematically shows an example of selection of a portion of a raster image, implemented by a processing circuit of a motion detection radar device;

FIG. 6 schematically shows examples of convolutions implemented by a processing circuit of a motion detection radar device;

FIG. 7 schematically shows examples of normalization and of thresholding, implemented by a processing circuit of a motion detection radar device;

FIG. 8 shows an example of lines obtained by the application of a Hough transform to a raster image, implemented by a processing circuit of a motion detection radar device;

FIG. 9 shows an example of the lines used during the application of a fast Hough transform on a raster image, implemented by a processing circuit of a motion detection radar device;

FIG. 10 schematically shows examples of calculations of correlations between raster images, implemented by a processing circuit of a motion detection radar device;

FIG. 11 schematically shows examples of masks used during calculations of correlations between raster images implemented by a processing circuit of a motion detection radar device; and

FIG. 12 schematically shows a comparison between positions of maximum values of radar waves reflected and received by a motion detection radar device and positions expected for a movement intended to be detected, implemented by a processing circuit of a motion detection radar device.

### DETAILED DESCRIPTION

Like features have been designated by like references in the various figures. In particular, the structural and/or functional features that are common among the various embodiments may have the same references and may dispose identical structural, dimensional and material properties.

For clarity, only those steps and elements which are useful to the understanding of the described embodiments have been shown and are described in detail. In particular, different elements (radar wave transceiver circuit, memory circuit, processing circuit, etc.) of the motion detection radar device are not detailed. Those skilled in the art will be capable of designing these elements in detail based on the functional description given herein.

Further, in the following description of the motion detection radar device used for the control of the opening and of the closing of a vehicle trunk door, the other elements, components, and/or circuits used for the control of the opening and of the closing of the vehicle trunk door are not described.

Unless indicated otherwise, when reference is made to two elements connected together, this signifies a direct connection without any intermediate elements other than conductors, and when reference is made to two elements coupled together, this signifies that these two elements can be connected or they can be coupled via one or more other elements.

In the following description, where reference is made to absolute position qualifiers, such as “front”, “back”, “top”, “bottom”, “left”, “right”, etc., or relative position qualifiers, such as “top”, “bottom”, “upper”, “lower”, etc., or orientation qualifiers, such as “horizontal”, “vertical”, etc., reference is made unless otherwise specified to the orientation of the drawings, in a normal position of use.

Unless specified otherwise, the expressions “about”, “approximately”, “substantially”, and “in the order of” signify plus or minus 10% or 10°, preferably of plus or minus 5% or 5°.

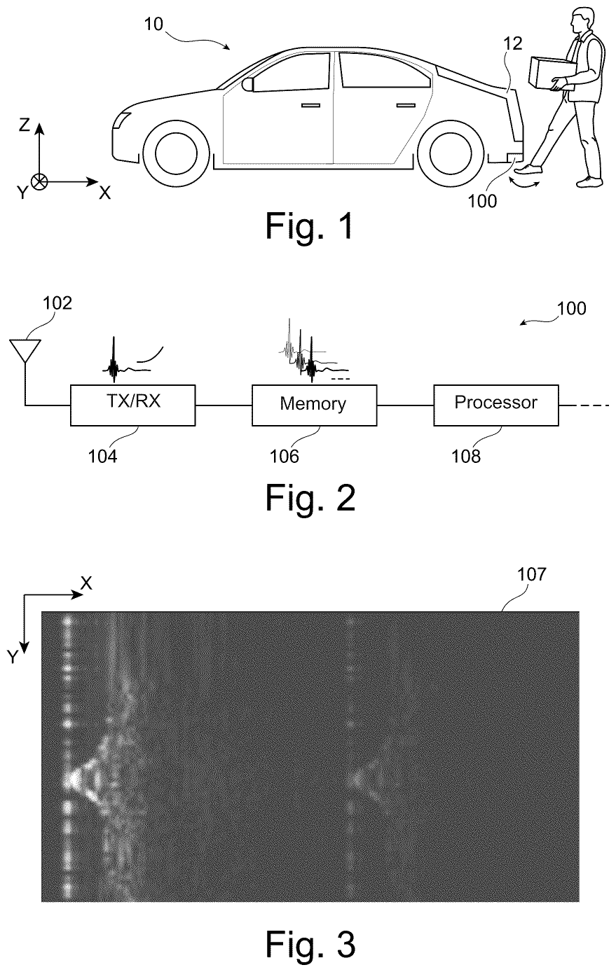

FIG. 1 schematically shows an example of a vehicle 10 comprising a motion detection radar device 100. In the example of FIG. 1, vehicle 10 corresponds to an automobile. As a variant, vehicle 10 may be a vehicle other than an automobile.

In the described example, device 100 is intended to control an opening and/or a closing of the trunk door 12 of vehicle 10 without for the user to have to press a control button. Device 100 is here arranged at the rear of vehicle 10, under the trunk of vehicle 10 and, for example, under or inside of the rear bumper of vehicle 10. As a variant, device 100 may be arranged inside of vehicle 10, for example in the trunk of vehicle 10. Further, along the width of vehicle 10 (parallel to the Y axis shown in FIG. 1), device 100 is, for example, arranged at the center of this width. Other arrangements of device 100 are possible, according to the role of device 100, which may be used to control something else than a trunk door opening and/or closing.

In the described example, device 100 is intended to detect whether the user performs, under the rear bumper of vehicle 10, a “kicking” motion, that is, a rapid back-and-forth movement of the foot under the rear bumper of vehicle 10, as symbolically shown in FIG. 1.

FIG. 2 schematically shows an example of embodiment of device 100.

Device 100 comprises at least one antenna 102 intended to transmit radar waves and to then receive, or detect, the reflected radar waves. The orientation of antenna 102 may in particular depend on the aperture angle of antenna 102, but also on the shape, or geometry, of the portion of vehicle 10 having device 100 located therein, in order to limit unwanted interference likely to be generated in this portion of vehicle 10. For example, in the example of FIG. 1, the antenna 102 of device 100 may be oriented so that the waves are transmitted from device 100 towards the ground by forming an angle of approximately 30° with respect to the Z axis, towards the rear of vehicle 10. As a variant, device 100 may comprise a first antenna intended for the transmission of radar waves and a second antenna, separate from the first antenna, intended for the reception of reflected radar waves.

In the described example, the radar waves to be transmitted and detected, after reflection, by device 100 are of Ultra Wideband (UWB) type. Such UWB radar waves for example have a frequency in the range from 3.1 GHz to 10.6 GHz. Further, device 100 may be configured to transmit radar waves over any channel defined by the IEEE 802.15.4/4z/4ab standard. Each of the UWB radar waves transmitted by device 100 has, for example, a duration in the order of 2 nanoseconds and a very low amplitude, for example such that the maximum power spectral density is −41.3 dBm/MHz at 500 MHz, and −61.3 dBm/MHz for frequency bands higher than 500 MHz.

Further, in the described embodiment, device 100 is configured to implement a motion detection such as described hereafter when the user is detected in the vicinity of device 100. Thus, prior to the steps relating to motion detection, a detection and a calculation of a distance with respect to a device capable of communicating with device 100 and intended to be carried by a user of vehicle 10 are implemented by the device 100. Such a distance may be calculated based on the travel time of radar waves between device 100 and the device communicating with device 100. The device capable of communicating with device 100 corresponds, for example, to a UWB tag, for example integrated in a key or a card of vehicle 10, or a portable device such as a smartphone. Thus, device 100 may implement these steps relative to motion detection (“radar” mode operation of device 100) only if the user is detected in the vicinity of vehicle 10 (“ranging” mode operation of device 100), for example at a distance shorter than 1 meter, which for example enables to avoid unintentional motion detections when the user is not in the vicinity of device 100 and thus an opening the trunk of the vehicle 10 is not desired.

When device 100 is configured to transmit and receive UWB waves, it is possible to perform the motion detection and the distance detection with the same circuits, due to the versatility of the characteristics of UWB waves, which enable to avoid having to use different sensors for these two operating modes. Further, the use of UWB waves also has the advantage of limiting the risk of destructive interference capable of affecting the useful part of the signal, and enables to have fewer echoes, given that the transmitted pulses are mainly absorbed by the objects encountered along their travel. Further, the use of UWB waves requires little pre-processing of the information, and offers a good security against hacking risks.

Another advantage of the use of UWB waves is that the properties of UWB signals (that is, the distinct channels and the use of codes for authentication) also improve the general performance and the security of device 100 as compared with standard radar systems.

Device 100 further comprises a circuit (TX/RX) 104 for transmitting and receiving radar waves. Such a circuit 104 may in particular comprise a low-noise amplifier (LNA), one or a plurality of filters, a signal correlator, a comparator, etc. Circuit 104 comprises an input and an output coupled to antenna 102. When device 100 comprises separate antennas for the transmission and the reception of radar waves, device 100 may comprise a plurality of separate transceiver circuits.

To perform a motion detection, circuit 104 is configured to transmit a sequence of radar waves for a certain duration. This duration may be selected so that it spans at least the time during which the user is intended to perform the movement intended to be detected by device 100. For example, this duration may be in the range from 3 to 10 seconds. Further, device 100 may be such that the distance over which the radar detection is performed is in the range from 0 to 1 meter from the vehicle body.

Device 100 also comprises a memory circuit 106 which, in the example of FIG. 2, comprises an input coupled to an output of circuit 104. On reception, by antenna 102 and circuit 104, of reflected radar waves, the data relative to these reflected radar waves are sent by circuit 104 to memory circuit 106. Memory circuit 106 is configured to store at least a first raster image representative of a spatiotemporal distribution of the energy of the reflected radar waves.

An example of such a raster image 107 formed from the radar waves reflected and received by device 100 is shown in FIG. 3. Each line (parallel to the X axis of FIG. 3) of this image represents the energy present in one of the radar waves reflected and received by device 100, and corresponds to a channel impulse response (CIR) acquired by device 100. Each of the lines of raster image 107 represents the energy level detected at a given time as a function of the distance with respect to device 100. Thus, the radar waves successively reflected and received over time by device 100 are represented by lines arranged one under the other along the Y axis of FIG. 3. Each column (parallel to the Y axis of FIG. 3) of this image represents the time variation of the energy captured by the radar waves at a given distance from device 100. In the example of FIG. 3, the left-hand side of raster image 107 corresponds to the side closest to device 100. Further, in this example, the higher the detected energy, the lighter the color of the pixel corresponding to this detected energy. For example, for a detection time in the range from 3 to 10 seconds and a radar wave transmission frequency in the order of 15 Hz, raster image 107 may comprise a number of rows approximately in the range from 45 to 150 and a number of columns approximately in the range from 33 to 100 if the radar waves are transmitted within a distance radius in the order of 1 meter, or approximately in the range from 100 to 300 if the radar waves are transmitted within a distance radius in the order of 3 meters.

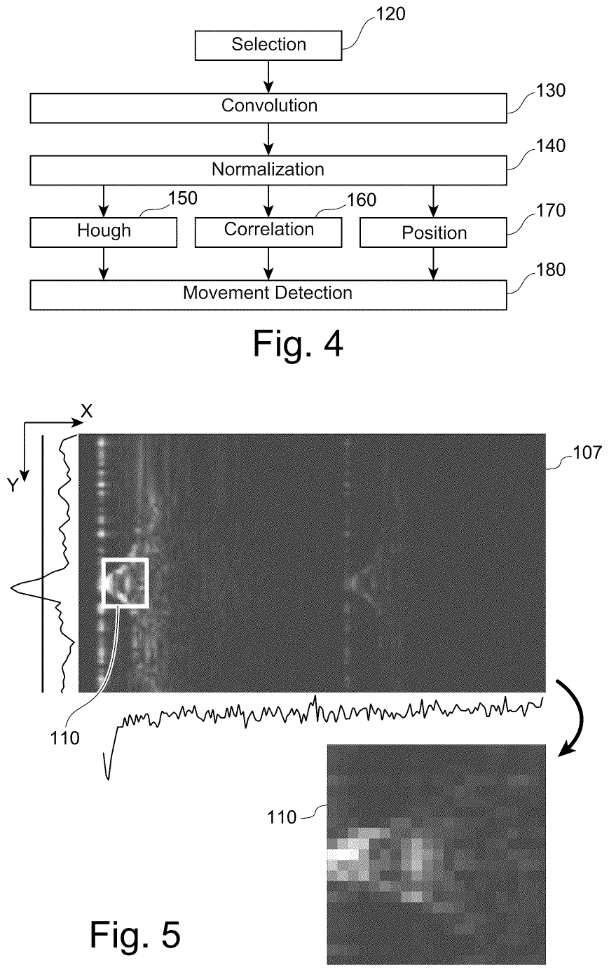

After the storage of the raster image obtained due to the detection of the reflected radar waves, device 100 implements steps of processing of the stored raster image in order to determine whether or not a movement, expected or intended to be detected by device 100, can be considered as having been detected. These processing steps will enable to perform a comparison, based on at least a portion of raster image 107, of the spatiotemporal distribution of the energy of the reflected radar waves with an expected spatiotemporal distribution of energy for at least one movement intended to be detected. Device 100 comprises a processing circuit 108 configured to implement these steps. FIG. 4 schematically shows an example of implementation of these processing steps.

In a specific embodiment, processing circuit 108 is configured to implement a selection of a portion of the previously-stored raster image 107. This selection is designated, in FIG. 4, as step 120. In this example, this selection is implemented in order to only retain the most relevant portion of raster image 107 and thus to implement the next processing steps only on this most relevant portion of raster image 107. This selection step enables to obtain the result of the detection or not of the movement more rapidly and/or with fewer computing resources.

When the data of raster image 107 comprise complex numbers (corresponding to the output data supplied by transceiver circuit 104), device 100 may first determine the absolute value of these complex numbers. These absolute values are then stored and used for the rest of the selection step. This step of determination of the absolute values of the data of raster image 107 cannot be implemented if transceiver circuit 104 is configured to output data in the form of real numbers.

The implementation of this selection step may then comprise a first image framing performing a selection of the columns of pixels of raster image 107 to be retained for the rest of the method. This first framing enables to select the distance range in which are located the relevant radar data relevant to determine whether or not the expected movement is detected, and to only retain these radar data. Considering the orientation of the raster image 107 shown in FIG. 3, this first framing corresponds to a horizontal framing of raster image 107.

According to a first example, this first framing may be carried out by arbitrarily selecting the pixel columns to be retained. For example, when the movement to be detected corresponds to a “kicking” movement by the user performed under the rear bumper of vehicle 10, it is possible to consider that the relevant data to be retained are at most one meter away from device 100.

According to a second example, this first framing may be achieved by selecting the pixel column of raster image 107 having the highest energy (selection for example performed by calculating the sum of the pixel values of the different pixel columns of the image) and by retaining a given, or arbitrary, number of next pixel columns of raster image 107. For example, when the movement to be detected corresponds to the “kicking” movement of the user performed under the rear bumper of vehicle 10, the pixel column of raster image 107 having the highest energy corresponds to the maximum distance reached by the user's foot under the rear bumper of vehicle 10. Based on this pixel column of maximum energy, it is possible to retain a number of next pixel columns corresponding to a distance in the range from 50 cm to 80 cm with respect to the pixel column of maximum energy.

The first framing enables not to retain data which concern regions of space in which the user is not performing the movement intended to be detected, as well as possible spurious data linked to effects of coupling of the antenna(s) of device 100.

The selection step may also comprise a second framing of raster image 107, performing a selection of the pixel lines of raster image 107 to be retained for the rest of the method. This second framing enables to select the time range including the radar data to be considered to determine whether or not the expected movement is detected, and to only retain these radar data. Considering the orientation of the raster image 107 shown in FIG. 3, this second framing corresponds to a vertical framing of raster image 107.

According to a first example, this second framing may be achieved by only retaining a given, or arbitrary, number of pixel lines on each side of a central pixel line corresponding to that having, in the entire raster image 107, the highest energy (selection for example performed by calculating the sum of the pixel values of the different pixel lines of the image). For example, on each side of the pixel line having the highest energy, it is possible to retain a number of pixel lines corresponding, as a whole, to a duration in the range from 1 to 2 seconds (that is, from 2 to 4 seconds of retained signal).

According to a second example, the second framing may be achieved by only retaining a given, or arbitrary, number of pixel lines on each side of a central pixel line corresponding to that having its position, in raster image 107, defined as corresponding to the mean or the median of the positions of the pixel lines having the sum of their pixel values exceeding a given threshold value. As for the first example, on each side of the central pixel line thus defined, it is possible to retain a number of pixel lines corresponding, as a whole, to a duration in the range from 1 to 2 seconds.

In the above examples concerning the second framing, the number of retained pixel lines may be constant and arbitrarily selected, or statistically calculated by considering, for example, the noise level in each of the pixel lines, or the standard deviation or mean between the pixel values of each pixel line of raster image 107.

At the end of the first and second framing operations, the selection of the portion of raster image 107 intended to be processed for the motion detection is completed.

FIG. 5 schematically shows a portion 110 of the raster image 107 selected as a result of the implementation of the previously-described steps. In FIG. 5, the energy of the different rows and columns of pixels is schematically shown on the border of raster image 107. Portion 110 corresponds to the portion of raster image 107 in which are located the energy peaks. In a specific embodiment, the selected portion 110 of raster image 107 may form a square raster image, that is, having a number of pixel rows equal to the number of pixel columns, and for example in the order of 20.

As an alternative to the example described hereabove, it is possible for the second framing to be carried out before the first framing. According to another variant, it is possible for this selection of a portion of raster image 107 not to be implemented and for the next steps implemented by processing circuit 108 to be implemented based on the complete raster image 107.

In the described specific embodiment, the circuit 108 of device 100 is configured to implement, after selection step 120, a convolution of raster image 107, and more particularly of the selected portion 110 of raster image 107 given the previous selection step 120 implemented in this example, and of a kernel (step 130). The kernel, or convolution matrix, used for this convolution may correspond to a square matrix of size 3×3, or 5×5, or 7×7, etc. The kernel may be Gaussian or correspond to a kernel comprising identical values, or also comprise different values and enable, for example, to apply a low-pass filter to portion 110 of raster image 107. As a variant, the kernel may comprise values such that the convolution performs a more significant filtering either on the axis of raster image 107 corresponding to the detection distance with respect to device 100 (X axis in the example of FIG. 3), or on the axis of raster image 107 corresponding to the time axis (Y axis in the example of FIG. 3). The implementation of such a convolution enables to perform a filtering while decreasing the required computing resources as compared with a conventional filtering.

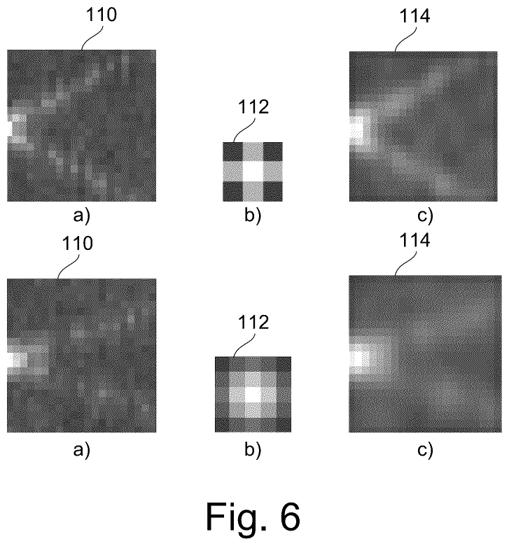

FIG. 6 shows examples of convolutions implemented on a portion 110 of raster image 107. In this drawing, image a) shows a selected portion 110 of raster image 107, image b) shows a first kernel 112 (corresponding, in this example, to a Gaussian matrix of dimensions 3×3), and image c) shows a raster image 114 resulting from the convolution performed between portion 110 a) and the kernel 112 of image b). Further, in this drawing, image d) shows a portion 110 of raster image 107, image e) shows a second kernel 112 (corresponding, in this example, to a Gaussian matrix of dimensions 5×5), and image f) shows a raster image 114 resulting from the convolution performed between portion 110 d) and the kernel 112 of image e).

Such a convolution step may enable to decrease the noise present in portion 110 of raster image 107 and/or to remove possible outliers present in portion 110 of raster image 107, and thus improve the motion detection performed by device 100. As a variant, it is possible for this convolution step not to be implemented by processing circuit 108.

In the described specific embodiment, the circuit 108 of device 100 is configured to implement, after selection step 120 (and before or after the previously-described convolution 130 if this convolution 130 is implemented), a step 140 of normalization of the values of the pixels of raster image 107, and more particularly of the selected portion 110 of raster image 107 given the previous selection step 120 implemented in this example, and a thresholding, that is, a selection of the pixels according to a comparison of their values with respect to a threshold value, of the normalized values of the pixels of raster image 107 (of the portion 110 of raster image 107 in this example).

According to a first example, the implemented normalization may comprise a subtraction, from the value of each of the pixels, of an average value of the pixels of the selected portion 110 of raster image 107, and a division of the values thus obtained by the standard deviation of these values.

According to a second example, the implemented normalization may comprise a subtraction, from the value of each of the pixels, of the minimum value of the pixels, and a division of the values thus obtained by the maximum value of these values.

According to a third example, the implemented normalization may comprise a subtraction, from the value of each of the pixels, of a constant value (arbitrarily selected or based on parameters of the image such as its noise level), and a division of the values obtained by the maximum value of these values.

In the three above examples, if negative values are obtained, they can be defined as being equal to 0.

According to a fourth example, the implemented normalization may comprise a division of the values of each pixel of the image by the maximum value of the pixels of the image.

After the normalization of the values of the image pixels, a thresholding of the normalized pixel values is implemented.

According to a first example, the thresholding may correspond to an operation consisting in only retaining the values of the pixels exceeding a threshold value and in defining at a zero value the values of the other pixels.

According to a second example, the thresholding may correspond to an operation consisting in defining at a maximum value all the pixels having a value exceeding a threshold value and in setting to a zero value the other pixels (which corresponds to a binary conversion of the image).

In these examples of thresholding, the threshold value may be constant, and predefined or dynamically defined based on statistical parameters of the values of the image pixels, such as the standard deviation between these values or the signal-to-noise ratio of the image. According to a variant, the threshold value may not be constant and decrease as a function of the distance R with respect to device 100, for example by following a 1/R⁴ curve, which enables to obtain an image in accordance with the attenuation naturally occurring with the increase in distance.

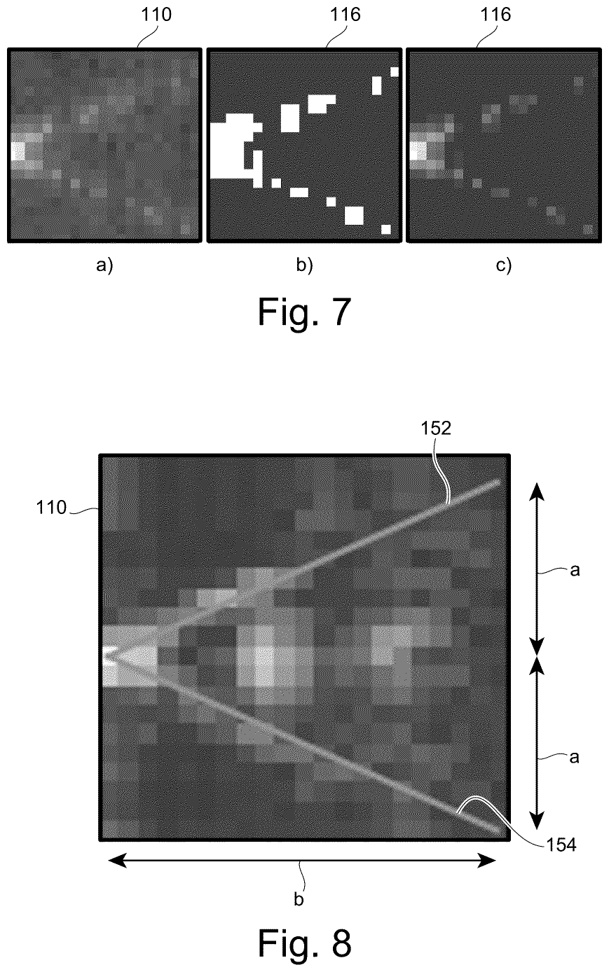

FIG. 7 shows examples of results obtained after the application of the previously-described normalization and thresholding operations to a selected portion 110 of raster image 107. In this drawing, image a) shows a selected portion 110 of raster image 107, image b) shows an example of a resulting image 116 obtained after the application of an example of normalization and of thresholding resulting in a binary conversion of the image, and image c) shows an example of a resulting image 116 obtained after the application of another example of normalization and thresholding.

As a variant, this step 140 may comprise the implementation of a thresholding only and not of a normalization.

The processing circuit 108 of device 100 is configured to implement, after selection 120 and/or the convolution 130 and/or the normalization 140 and/or the thresholding of the pixel values previously described as a function of the implemented steps, a comparison of the spatiotemporal distribution of the energy of the reflected radar waves with a spatiotemporal distribution expected for the movement intended to be detected by device 100. In the described example, this comparison will correspond to the implementation of at least one of the separate steps designated with reference 150, 160, and 170, and each delivering as an output a detection variable having a value representative of the detection or not of the expected movement.

At step 150, a Hough transform is applied to the previously-obtained data, that is, the data obtained at the outcome of the thresholding step in the described example. The application of such a Hough transform to the image data amounts to searching in the image for lines running through the pixels representative of the presence of energy, that is, the image pixels in which a movement is detected. The search for such lines in the image is relevant, in particular, when the movement intended to be detected by device 100 corresponds to a kicking performed in front of device 100, since the back-and-forth movement of the foot follows, in raster image 107, two lines running through an intersection corresponding to the time when the user's foot returns to its initial position.

According to a first example, the Hough transform may be a so-called standard Hough transform, resulting in the search in the entire image (in the entire portion 110 of raster image 107 in the example described herein) for such lines, each defined by a point of origin, a slope, and a value of the sum of the values of the pixels having this line running therethrough. FIG. 8 shows an example of lines, designated with references 152 and 154, obtained by the application of the Hough transform to portion 110 of raster image 107. In the described example, the slope of each of these lines is defined as being equal to the ratio of their dimensions a/b, with dimension a corresponding to the dimension along the time axis and dimension b corresponding to the dimension along the distance axis.

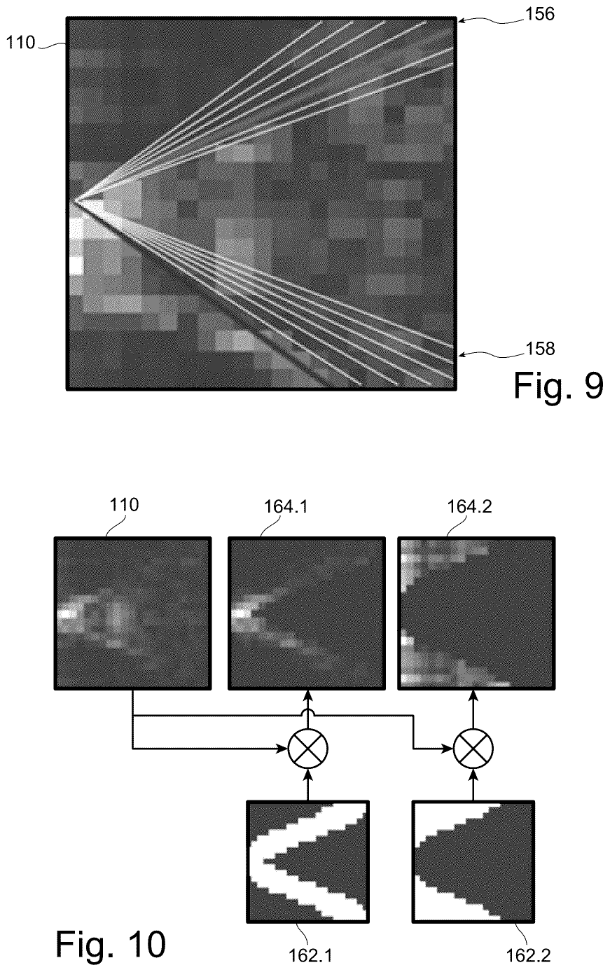

According to a second example, the Hough transform may be a so-called fast Hough transform, resulting in the search, from among a set of predefined lines (by selecting a point of origin and a restricted range of positive and negative slope values), for those running through the pixels representative of the presence of energy. As an example, the set of predefined lines may comprise from 5 to 10 lines having positive slopes and from 5 to 10 lines having negative slopes. As with the standard Hough transform, the identified lines are defined by a slope and a value of the sum of the pixel values having this line running therethrough. FIG. 9 shows an example of two sets of predefined lines 156, 158 used for the application of a fast Hough transform. This second example may be advantageous, since less computing resource-intensive than the use of a so-called standard Hough transform.

After the application of the Hough transform, at least part of the parameters of the resulting lines (slope and sum of the pixel values) are used to determine the value of the first motion detection variable, that is, determine whether the expected movement is present in the raster image.

According to a first example, the movement may be considered as having been detected if the absolute values of the slopes of the two identified lines are identical and these slopes are opposite, that is, if the two identified lines are symmetrical with respect to a horizontal line of the image in the described example of embodiment.

According to a second example, the movement may be considered as having been detected if the absolute values of the slopes of the two identified lines are identical and these slopes are opposite, and if a difference between the sums of the values of the pixels having each of these lines running therethrough does not exceed a certain threshold value, for example called threshold value of the difference between sums of pixel values.

According to a third example, the movement may be considered as having been detected if a difference between the absolute values of the slopes of the two identified lines is smaller than or equal to a certain threshold value, called for example slope difference threshold value, and these slopes are opposite.

According to a fourth example, the movement may be considered as having been detected if a difference between the absolute values of the slopes of the two identified lines is smaller than or equal to a threshold value of difference between sums and these slopes are opposite, and if the sums of the pixel values having each of these lines running therethrough do not exceed a threshold value of the difference between sums of pixel values.

According to a fifth example, it is possible to apply one of the four previous examples and to consider that the movement is detected if, further, the sums of pixel values of each of the two lines are smaller than those of other predefined lines (for example, the set of lines running through the same point of origin as that of the identified lines, or lines running through the same point of origin and having the absolute values of the slopes closest to those of the identified lines).

Depending on the characteristics of the identified lines, and according to the criteria of one of the above examples, a first detection variable is defined as being equal to a first value or a second value according to whether the expected movement is considered as being detected or not, for example to a value ‘1’ if the expected movement is considered as having been detected and to a value ‘0’ if the expected movement is considered as not having been detected.

At step 160, a calculation of a correlation between previously-obtained data, that is, the data obtained at the outcome of the thresholding step in the described example, and those of a second raster image in which a first part of the pixels have their values defined at a maximum value and a second part of the pixels have their values defined at a minimum value, is carried out. In the described example of embodiment, this correlation is calculated based on the data from the selected portion 110 of raster image 107. This step 160 is implemented to perform an expected motion detection by calculating the product of the raster image with one or a plurality of 2D masks, corresponding to the second raster image(s). The image(s) resulting from this correlation enable to determine whether the energy of the first raster image 107 is present or absent from certain regions defined by the mask(s), which determination can be achieved by measurements or calculations of one or a plurality of statistical characteristics of the image(s) resulting from this correlation calculation and based on the comparisons of these characteristics with respect to threshold correlation values.

FIG. 10 schematically shows the results of two convolutions based on a same portion 110 of raster image 107, and using two different masks, bearing references 162.1 and 162.2. A first one of these two masks 162.1 comprises a first part of its pixels, the values of which are defined at a maximum value and which correspond to regions where the energy due to the movement to be detected is intended to be present in portion 110 of raster image 107, and a second part of its pixels, the values of which are defined at a minimum value and which corresponds to regions where the energy due to the movement to be detected is intended to be absent in portion 110 of raster image 107. Second mask 162.2 is, conversely to first mask 162.1, such that a first part of its pixels, the values of which are defined at a maximum value corresponding to regions where the energy due to the movement to be detected is intended to be absent in portion 110 of raster image 107, and a second part of its pixels, the values of which are defined at a minimum value which corresponds to regions where the energy due to the movement to be detected is intended to be present in portion 110 of raster image 107. In FIG. 10, the images resulting from these correlations are designated with references 164.1 and 164.2. With such correlations, it is possible to consider that the expected movement has been detected if the energy present in the image resulting from the second correlation is smaller than that present in the image resulting from the first correlation.

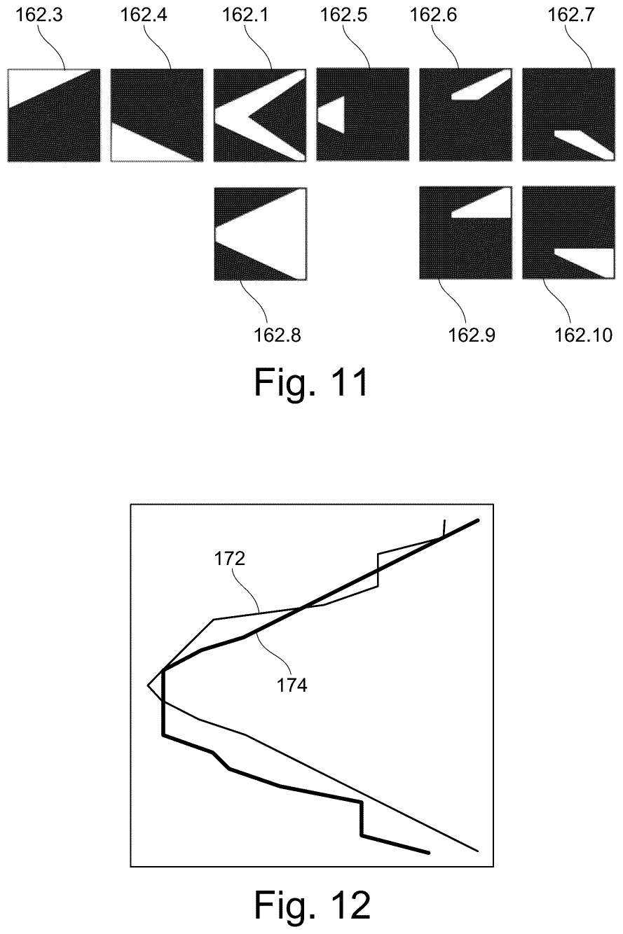

Different examples of masks usable for this correlation step are shown in FIG. 11. In these examples, the combination of masks 162.3 and 162.4 forms the second mask 162.1 used in the second correlation previously described in relation with FIG. 10, and mask 162.1 corresponds to that used for the first correlation previously described in relation with FIG. 10. Other examples of masks 162.5 to 162.10 are shown and may be used for the implementation of correlations as a substitute or a replacement of the previously-described correlations.

Based on the resulting image(s) obtained by implementing such correlations, one or a plurality of the following statistical characteristics of this or these image(s) may be calculated: sum of the values of all the pixels of the resulting raster image, maximum value of the pixels of the resulting raster image, mean value of the pixels of the resulting image, variation coefficient of the pixels of the resulting image (that is, the ratio of the standard deviation to the mean of these values). The value(s) of the described statistical characteristic(s) are then compared with one or a plurality of threshold correlation values to determine whether the expected motion is detected.

According to a first example, it is possible to perform a correlation of the image data obtained at the outcome of step 140 with the mask 162.1 of FIG. 11, and to calculate whether one of the statistical parameters of the resulting image is greater than a threshold correlation value.

According to a second example, it is possible to perform a correlation of the data of the image obtained at the outcome of step 140 with the mask 162.8 of FIG. 11, and to calculate whether one of the statistical parameters of the resulting image is greater than a threshold correlation value.

According to a third example, it is possible to perform a first correlation of the data of the image obtained at the outcome of step 140 with mask 162.3 and to determine whether one of the statistical parameters of the resulting image is smaller than a first threshold correlation value, a second correlation with mask 162.4 and to determine whether one of the statistical parameters of the resulting image is smaller than a second threshold correlation value, and to perform a third correlation corresponding to one of those described hereabove for the first and second examples.

According to a fourth example, it is possible to perform the correlations previously described in relation with the third example, as well as other correlations of the data of the image obtained at the outcome of step 140 with masks 162.5, 162.6, and 162.7, or with masks 162.5, 162.9, and 162.10, and to determine whether one of the statistical parameters of each of the resulting images is greater than a threshold correlation value.

As a variant, it is possible to use masks symmetrical to one another and to compare the results of the correlations performed to see whether the energy is symmetrically distributed in the raster image. This may help decreasing false detections due to noise.

The different threshold correlation values used may be arbitrarily selected, or calculated from statistical characteristics of the raster image (maximum value, mean, standard deviation, variation coefficient, noise level, etc.), or dynamically calculated by comparison of different correlations with one another. For example, it is possible to consider that the movement is detected if the result of the correlation between the raster image and the combination of masks 162.3 and 162.4 is lower than the result, weighted by a factor α having its value selected beforehand, of the correlation between the raster image and mask 162.1.

Depending on the result(s) of the correlations performed, a second detection variable is defined at a first value or a second value according to whether the expected movement is considered as detected or not, for example at a value ‘1’ if the expected movement is considered as detected and at a value ‘0’ if the expected movement is considered as not having been detected.

Masks different from those described hereabove may be used. According to an example, one or a plurality of the masks used may be such that the first part of the pixels of this or these mask(s) corresponds to at least one region of highest energy of the expected spatiotemporal energy distribution. It is also possible to use, as a complement, one or a plurality of masks such that the first part of the pixels of this or these mask(s) corresponds to at least one region of lowest energy of the expected spatiotemporal energy distribution.

At step 170, the position of a maximum value of each of the reflected radar waves, that is, of each line of raster image 107, or of the portion 110 of raster image 107 in the described example, is calculated and compared with expected positions of a maximum value of an energy generated by the movement to be detected. For this purpose, it is for example possible to implement the following steps: a calculation of a first vector comprising the values of the positions of the maximum values of the reflected radar waves, then a calculation of a cross-correlation between at least a portion of the first vector and at least a portion of a second vector comprising the values of the expected positions of the maximum value of the energy generated by the movement intended to be detected, and then a comparison of a calculated cross-correlation value with a threshold cross-correlation value, where this threshold value may be constant or a function of one or a plurality of static parameters of the image (noise, mean, standard deviation, maximum value, etc.).

FIG. 12 schematically shows the plots obtained for the first vector designated with reference 172 and the second vector designated with reference 174.

The length of the vectors depends in particular on the size of the raster image. As a variant, it is possible to only take into account a portion of the raster image, for example for a given duration on each side of the center line of the image, which is the case when portion 110 of raster image 107 is selected.

This step 170 can be seen as a binarization of the raster image in which for each line, the most energetic and the leftmost pixel of the image is retained.

In the above examples, at least one of steps 150, 160, and 170 is implemented based on the data obtained at the end of step 140. As a variant, when step 140 is not implemented by the processing circuit, it is possible for at least one of steps 150, 160, and 170 to be implemented based on the data obtained at the end of step 130. According to another variant, when step 130 is not implemented by processing circuit 108, it is possible for at least one of steps 150, 160, and 170 to be implemented based on the data obtained at the end of step 120, that is, that of portion 110 of raster image 107. Finally, when step 120 is not implemented by processing circuit 108, it is possible for at least one of steps 150, 160, and 170 to be implemented based on the data of raster image 107.

In the described example of embodiment, processing circuit 108 is configured to confirm, in a decision step 180, the detection or not of the movement based on the value of at least one of the detection variables supplied by each of steps 150, 160, and 170. According to a first example, the movement may be considered to have been detected if at least one of the detection variables has a value confirming the detection of the expected movement. According to a second example, the movement may be considered as having been detected if at least two of the detection variables each have a value confirming the detection of the expected movement. According to a third example, the movement may be considered as having been detected if all the detection variables each have a value confirming the detection of the expected movement. Other examples of combinations may be envisaged for this step 180, such as for example considering that the movement is detected only if one of the detection variables in particular necessarily has a value confirming the detection of the expected movement. According to the number of detection variables used for the motion detection, it is possible to only implement one, two, or the three steps 150, 160, 170.

According to an example, when step 160 is implemented, the prior implementation of step 140 is advantageous. According to another example, when step 170 is implemented, the prior implementation of step 130 is advantageous.

In the different above examples, the different threshold values used may be selected according to the characteristics of device 100, to the type of detected movement, to the operating environment of device 100, etc.

In the above-described examples, the different steps relative to the detection of an expected movement are implemented by processing circuit 108 when the user is previously detected in the vicinity of vehicle 10. As a variant, it is possible to carry out the detection of the distance of the user from vehicle 10 after the implementation of the steps allowing the motion detection, the result of this motion detection being, for example, only provided when the user is detected as being in the vicinity of vehicle 10.

In the various above-described examples, device 100 is configured to form, via the detection of reflected radar waves, images of time-distance representations of the energy of the received radar echoes.

Device 100 allows a processing of reflected radar waves based on image processing techniques without using complex training techniques, for example without artificial intelligence, and directly implemented on the raw radar signals received.

The device is, for example, intended for the automotive industry. The electrification of motor vehicles generates more and more electronic content in vehicles. Driving automation also generates more and more electronic content in vehicles.

Device 100 may more generally apply to the field of vehicles. For example, device 100 may apply to enable a hands-free opening, or control, of a motor vehicle trunk, tailgate, or other component of the vehicle.

As a variant, device 100 may be used in fields other than those of vehicles and automobiles.

Various embodiments and variants have been described. Those skilled in the art will understand that certain features of these various embodiments and variants may be combined, and other variants will occur to those skilled in the art.

Finally, the practical implementation of the described embodiments and variants is within the abilities of those skilled in the art based on the functional indications given hereabove.

1. A radar motion detection device, comprising at least:
a transceiver circuit configured to transmit a sequence of radar waves and configured to receive a sequence of reflected radar waves;
a memory circuit configured to store at least a first raster image representative of a spatiotemporal distribution of energy of the reflected radar waves; and
a processing circuit configured to perform at least one comparison, based on at least one portion of the first raster image, of the spatiotemporal distribution of energy of the reflected radar waves with an expected spatiotemporal distribution of energy corresponding to at least one movement which is intended to be detected.

2. The motion detection radar device according to claim 1, wherein the processing circuit is configured so that the at least one comparison comprises an application of a Hough transform to said at least one portion of the first raster image, and wherein the processing circuit is configured to determine a value of a first motion detection variable as a function of values of slopes of lines obtained by the application of the Hough transform to said at least one portion of the first raster image.

3. The motion detection radar device according to claim 2, wherein the processing circuit is configured to determine that the at least one movement is detected when absolute values of slopes of two lines obtained by the application of the Hough transform are equal and values of the slopes are opposite.

4. The motion detection radar device according to claim 3, wherein the processing circuit is further configured to determine that the at least one movement is detected when a difference between sums of a value of pixels having each of the two lines running therethrough is smaller than a threshold value of a difference between sums of pixel values.

5. The motion detection radar device according to claim 3, wherein the processing circuit is further configured to determine that the at least one movement is detected when a difference between sums of pixel values of each of the two lines is smaller than sums of predefined lines.

6. The motion detection radar device according to claim 2, wherein the processing circuit is configured to determine that the at least one movement is detected when a difference between absolute values of the slopes of two lines obtained by the application of the Hough transform is smaller than a threshold value of the difference between slopes, and values of the slopes are opposite.

7. The motion detection radar device according to claim 6, wherein the processing circuit is further configured to determine that the at least one movement is detected when a difference between sums of the value of pixels having each of the two lines running therethrough is smaller than a threshold value of a difference between sums of pixel values.

8. The motion detection radar device according to claim 6, wherein the processing circuit is further configured to determine that the at least one movement is detected when a difference between sums of pixel values of each of the two lines is smaller than sums of predefined lines.

9. The motion detection radar device according to claim 1, wherein the processing circuit is configured so that the implemented comparison comprises at least one calculation of a correlation between said at least one portion of the first raster image and at least a second raster image in which a first part of the pixels have pixel values defined at a maximum value and a second part of the pixels have pixel values defined at a minimum value, and further configured to determine the value of a second motion detection variable as a function of a result of the comparison between at least one statistical characteristic of a result of the calculated correlation and a threshold correlation value.

10. The motion detection radar device according to claim 9, wherein the processing circuit is configured so that the statistical characteristic corresponds to the sum of the pixel values of a third raster image corresponding to the result of the calculated correlation.

11. The motion detection radar device according to claim 9, wherein the processing circuit is configured so that the statistical characteristic corresponds to the maximum value of the pixels of the third raster image.

12. The motion detection radar device according to claim 9, wherein the processing circuit is configured so that the statistical characteristic corresponds to the mean value of the pixels of the third raster image.

13. The motion detection radar device according to claim 9, wherein the processing circuit is configured so that the statistical characteristic corresponds to the value of the ratio of the standard deviation to the mean of the values of the pixels of the third raster image.

14. The motion detection radar device according to claim 9, wherein the processing circuit is configured so that the first part of the pixels of the second raster image corresponds to at least a region of highest energy of the expected spatiotemporal distribution of energy.

15. The motion detection radar device according to claim 1, wherein the processing circuit is configured so that the comparison is implemented between a position of a maximum value of each of the reflected radar waves and expected positions of a maximum value of an energy generated by the at least one movement intended to be detected, and further configured to determine the value of a third motion detection variable as a function of differences between the position of the maximum value of each of the reflected radar waves and expected positions of the maximum value of the energy generated by the at least one movement intended to be detected.

16. The motion detection radar device according to claim 15, wherein the processing circuit is configured so that the implemented comparison comprises:
a calculation of a first vector comprising values of positions of the maximum values of the reflected radar waves;
a calculation of a cross-correlation between at least a portion of the first vector and at least a portion of a second vector comprising values of expected positions of the maximum value of the energy generated by the movement to be detected; and
a comparison of a calculated cross-correlation value with a threshold cross-correlation value.

17. The motion detection radar device according to claim 1, wherein:
the processing circuit is configured to determine a value of a first motion detection variable as a function at least of values of slopes of lines obtained by application of a Hough transform to said at least one portion of the first raster image;
the processing circuit is configured so that the implemented comparison comprises at least one calculation of a correlation between said at least a portion of the first raster image and at least a second raster image in which a first part of the pixels have pixel values defined at a maximum value and a second part of the pixels have pixel values defined at a minimum value, and further configured to determine the value of a second motion detection variable as a function of a result of the comparison between at least one statistical characteristic of a result of the calculated correlation and a threshold correlation value; and
the processing circuit is configured so that the comparison is implemented between a position of a maximum value of each of the reflected radar waves and expected positions of a maximum value of an energy generated by the movement intended to be detected, and further configured to determine the value of a third motion detection variable as a function of differences between the position of the maximum value of each of the reflected radar waves and expected positions of the maximum value of the energy generated by the movement intended to be detected; and
the processing circuit is further configured to confirm detection or not of the at least one movement as a function of the value of at least one of the first, second, and third detection variables.

18. The motion detection radar device according to claim 1, wherein the processing circuit is configured to implement, prior to the comparison, a selection of a portion of the first raster image, the comparison then being implemented based on the selected portion of the first raster image.

19. The motion detection radar device according to claim 1, wherein the processing circuit is configured to implement, prior to the comparison, a normalization of the values of the pixels of said at least a portion of the first raster image and a thresholding of the normalized values of the pixels of said at least a portion of the first raster image, and so that the comparison is implemented based on the normalized and thresholded values of the pixels of said at least a portion of the first raster image.

20. The motion detection radar device according to claim 1, wherein the processing circuit is configured to implement, prior to the comparison, a convolution of said at least a portion of the first raster image and of a kernel, and so that the comparison is then implemented based on a raster image resulting from the convolution of said at least a portion of the first raster image and of the kernel.

21. The motion detection radar device according to claim 1, wherein the transceiver circuit is configured to transmit and receive ultra wide band (UWB) type radar waves, and to transmit the radar wave sequence when a user is detected in the vicinity of the motion detection radar device.

22. A vehicle, comprising:
at least one trunk door having a controllable opening and/or closing; and
the motion detection radar device according to claim 1 configured to control the opening and/or closing of the at least one trunk door.

23. A motion detection method, comprising:
transmitting a sequence of radar waves;
receiving a sequence of reflected radar waves;
storing at least a first raster image representative of a spatiotemporal distribution of energy of the reflected radar waves; and
comparing, based on at least a portion of the first raster image, the spatiotemporal distribution of energy of the reflected radar waves with an expected spatiotemporal distribution of energy corresponding to at least one movement intended to be detected.

24. The motion detection method according to claim 23, further comprising, prior to comparing, selecting a portion of the first raster image, wherein comparing comprises a comparison implemented based on the selected portion of the first raster image.

25. The motion detection method according to claim 23, further comprising, prior to comparing, normalizing pixel values of said at least a portion of the first raster image and thresholding normalized pixel values of said at least a portion of the first raster image, wherein comparing comprises a comparison implemented based on the normalized and thresholded values of the pixels of said at least a portion of the first raster image.

26. The motion detection method according to claim 23, further comprising, prior to comparing, performing a convolution of said at least a portion of the first raster image and a kernel, wherein comparing comprises a comparison based on a raster image resulting from the convolution of said at least a portion of the first raster image and of the kernel.

27. The motion detection method according to claim 23, further comprising, prior to transmitting the radar wave sequence, detecting presence of a user in a vicinity of a motion detection radar device implementing the method, the transmission of the radar wave sequence then being implemented in response to detection of the user.
